(19) United States
(12) Patent Application Publication
(10) Pub. No.: US 2020/0240770 A1
(43) Pub. Date: Jul. 30, 2020

(54) Device and Method for Calibrating a Measuring Apparatus Using Projected Patterns and a Virtual Plane

(71) Applicant: Siemens Aktiengesellschaft, München (DE)

(72) Inventors: Thomas Engel, Aalen (DE); Patrick Wissmann, München (DE)

(73) Assignee: Siemens Aktiengesellschaft, München (DE)

(21) Appl. No.: 16/486,979

(22) PCT Filed: Feb. 1, 2018
(86) PCT No.: PCT/EP2018/052562

§ 371 Date: Aug. 19, 2019

(30) Foreign Application Priority Data
Feb. 20, 2017 (DE) 10 2017 202 651.0

(51) Int. Cl. G01B 11/25; G01B 21/04; G06T 7/80

(52) U.S. Cl. CPC G01B 11/2504; G06T 7/80; G01B 21/042; G01B 11/2513

(57) ABSTRACT

Various embodiments include a device for calibrating a measuring apparatus for measuring a measurement object extending along an axis in space, the device comprising: an active region recording an entirety of the measurement object; a light projector generating at least two different calibration patterns into the active region onto a real plane wall or real plane surface; and a processor calculating the real plane wall or real plane surface as an ideally plane wall or ideally plane surface and using the calculation for calibration.

### CROSS-REFERENCE TO RELATED APPLICATIONS

This application is a U.S. National Stage Application of International Application No. PCT/EP2018/052562 filed Feb. 1, 2018, which designates the United States of America, and claims priority to DE Application No. 10 2017 202 651.0 filed Feb. 20, 2017, the contents of which are hereby incorporated by reference in their entirety.

### TECHNICAL FIELD

The present disclosure is related to measuring apparatus. The teachings herein may be embodied in devices and/or methods for calibrating a measuring apparatus using projected patterns and a virtual plane.

### BACKGROUND

For large components, measuring systems which have a large recording region are preferred; thus, for example, in the case of a so-called “Lavona Scanner”, which has an experience region of 2-2.5 m². So that the required calibration can be carried out rapidly, it is favorable to have a calibration target which, as far as possible, has the size of the entire measurement region. Since, for networking the measurements at different depths of the measurement region, measurement is likewise carried out with an obliquely placed target, the target should ideally be larger by the factor 1/cos(tilt angle relative to the normal). In the example, this would then be about 2.5-3 m².

Such large calibration targets are difficult to produce, in particular with the appropriate accuracy, and are therefore very expensive. Furthermore, they are already difficult to handle if only because of their size. Since they must be configured very stably for a required stability and geometrical accuracy in the range of 10 μm, they are likewise correspondingly heavy. Conventionally, this problem is solved by using smaller targets and displacing these in the measurement region in such a way that they then, for example, need to be brought to new positions for a plane. This is very time-consuming and labor-intensive, and calibration therefore takes a very long time. In the course of the calibration, for example, the environmental conditions may then likewise vary greatly, which may then significantly reduce the accuracy achievable by the calibration. Examples of this might be different insolation in the measurement region, which may influence both the temperature and the contrast ratios during the recording of the calibration images.

Thus, if the desire is to carry out measurement in five planes with three tilt angles per plane, this entails 15 measurements. Even if only nine measurements are required per plane, 9*15=135 measurements would then already be necessary. During the calibration, there likewise needs to be a measurement reference for the camera, since the optical recording with the camera only records the angular size of the object. At least one measurement reference is then needed so that lateral dimensions can then also be measured from the angular size and the distance. Calibration plates themselves are usually also calibrated so that the individual structures on the calibration plate are known in terms of size and/or position.

It is an object, when measuring a large component by means of measuring systems with a correspondingly large recording region, to carry out calibration straightforwardly. Elaborate calibration targets, for example calibration tables and calibration marks, are intended to be avoided. A scale or measurement references are intended to be provided in a simpler way. Calibration in metrology is a measuring process for reliably reproducible establishment and documentation of the deviation of one measuring apparatus or one measurement reference from another apparatus or another measurement reference, which in this case is referred to as normal. In a further definition, calibration may involve a second step, namely taking the identified deviation into account during subsequent use of the measuring apparatus in order to correct the values which are read.

### SUMMARY

Some embodiments of the teachings of the present disclosure include a device for calibrating a measuring apparatus for measuring a measurement object which extends, in particular, along a region in meters in space, having a recording region which records the entire measurement object, different calibration patterns (Mi) being projected by means of a light projector into the recording region of the measuring apparatus onto a real plane wall or real plane surface, characterized in that, by means of a computer instrument, the real plane wall or real plane surface is mathematically calculated as an ideally plane wall or ideally plane surface, and this is used for the calibration.

In some embodiments, by means of the computer instrument and a plurality of recordings of the measuring apparatus, the quality of the real plane wall or real plane surface is mathematically calculated and the effect of this quality is mathematically taken into account.

In some embodiments, by means of the computer instrument, calibration parameters are determined in one step or intrinsic and external calibration parameters are determined separately in two steps.

In some embodiments, by means of a polarizer or a beam splitter (5), or by means of different light wavelengths, at least two calibration patterns (M1, M2), laterally spatially displaced with respect to one another by a beam offset (SV) providing a measurement reference, are produced.

In some embodiments, the light projector comprises a light source (1), in particular a laser, collimation optics (2) and a pattern generator (3), in particular a pattern plate.

In some embodiments, the pattern plate is configured as a transmission structure, as a refractive, diffractive or reflective structure, or as a computer-generated hologram.

In some embodiments, the light projector comprises a coherent or semicoherent light source (1), a coherence reducer (7), in particular speckle suppression, being positioned between the pattern generator (3) and collimation optics (2) arranged after the light source (1) in the beam path.

In some embodiments, the coherence reducer (7) consists of birefringent plane-parallel plates.

In some embodiments, a multiplicity of plates are arranged successively in the beam path, principal axes of a respective plate being rotated with respect to the principal axes of the preceding plate by an angle, in particular by 45°, in particular by means of a correction prism (9).

In some embodiments, a respective calibration pattern (M) comprises geometrical shapes, in particular points, circles, crosses, squares or line portions.

In some embodiments, the geometrical shapes are position-encoded.

In some embodiments, the geometrical shapes have a predetermined angular size.

In some embodiments, by means of the computer instrument, an angular error between mutually displaced parts is taken into account by means of triangulation during the calibration.

In some embodiments, the entire device or constituent parts of the device and the space, the recording region or the plane wall or plane surface are movable relative to one another.

In some embodiments, the light projector consists of material with a low thermal expansion coefficient, in particular Zerodur, Suprasil, fused silica.

In some embodiments, the light projector is optically stabilized, in particular by means of an absorption cell or a reference station.

As another example, some embodiments include a method for calibrating a measuring apparatus for measuring a measurement object which extends, in particular, along a region in meters in space, having a recording region which records the entire measurement object, different calibration patterns (Mi) being projected (S1) by means of a light projector into the recording region of the measuring apparatus onto a real plane wall or real plane surface, characterized in that by means of a computer instrument, the real plane wall or real plane surface is mathematically calculated as an ideally plane wall or ideally plane surface, and this is used for the calibration.

In some embodiments, by means of the computer instrument and a plurality of recordings of the measuring apparatus, the quality of the real plane wall or real plane surface is mathematically calculated and the effect of this quality is mathematically taken into account.

In some embodiments, by means of a computer instrument, calibration parameters are determined in one step or intrinsic and external calibration parameters are determined separately in two steps.

In some embodiments, by means of a polarizer or a beam splitter (5), or by means of different light wavelengths, two calibration patterns (M1, M2) laterally spatially displaced with respect to one another by a beam offset providing a measurement reference or scale are produced (S2).

In some embodiments, the light projector comprises a light source (1), in particular a laser, collimation optics (2) and a pattern generator (3), in particular a pattern plate.

In some embodiments, the pattern plate is configured as a transmission structure, as a refractive, diffractive or reflective structure, or as a computer-generated hologram.

In some embodiments, the light projector comprises a coherent or semicoherent light source (1), a coherence reducer (7), in particular speckle suppression, being positioned between the pattern generator (3) and collimation optics (2) arranged after the light source (1) in the beam path.

In some embodiments, the coherence reducer (7) consists of birefringent plane-parallel plates.

In some embodiments, a multiplicity of plates are arranged successively in the beam path, principal axes of a respective plate being rotated with respect to the principal axes of the preceding plate by an angle, in particular by 45°.

In some embodiments, a respective calibration pattern (M) comprises geometrical shapes, in particular points, circles, crosses, squares or line portions.

In some embodiments, the geometrical shapes are position-encoded.

In some embodiments, the geometrical shapes have a predetermined angular size.

In some embodiments, by means of a computer instrument, an angular error between mutually displaced parts is taken into account (S3) by means of triangulation during the calibration.

In some embodiments, the entire device or constituent parts of the device and the space, the recording region or the plane wall or plane surface are movable relative to one another.

In some embodiments, the light projector consists of material with a low thermal expansion coefficient, in particular Zerodur, Suprasil, fused silica.

In some embodiments, the light projector is optically stabilized, in particular by means of an absorption cell or a reference station.

### BRIEF DESCRIPTION OF THE DRAWINGS

Various embodiments of the teachings herein are described in more detail in connection with the figures, in which:

FIG. 1 shows a first exemplary embodiment of a device incorporating teachings of the present disclosure;

FIG. 2 shows a second exemplary embodiment of a device incorporating teachings of the present disclosure;

FIG. 3 shows a third exemplary embodiment of a device incorporating teachings of the present disclosure;

FIG. 4 shows a fourth exemplary embodiment of a device incorporating teachings of the present disclosure;

FIG. 5 shows a first exemplary embodiment of a method incorporating teachings of the present disclosure;

FIG. 6 shows a first representation of a pattern projection incorporating teachings of the present disclosure;

FIG. 7 shows a second representation of a pattern projection incorporating teachings of the present disclosure;

FIG. 8 shows a third representation of a pattern projection incorporating teachings of the present disclosure; and

FIG. 9 shows a second embodiment of a method incorporating teachings of the present disclosure.

### DETAILED DESCRIPTION

In some embodiments, a device for calibrating a measuring apparatus for measuring a measurement object which extends, in particular, along a region in meters in space, having a recording region which records the measurement object, wherein different calibration patterns are projected by means of a light projector into the recording region of the measuring apparatus onto a real plane wall or real plane surface. By means of a computer instrument, the real plane wall or real plane surface is mathematically calculated as an ideally plane wall or ideally plane surface, and this is used for the calibration.

In some embodiments, a method for calibrating a measuring apparatus for measuring a measurement object which extends, in particular, along a region in meters in space, having a recording region which records the entire measurement object, includes projecting different calibration patterns by means of a light projector into the recording region of the measuring apparatus onto a real plane wall or real plane surface. By means of a computer instrument, the real plane wall or real plane surface is mathematically calculated as an ideally plane wall or ideally plane surface, and this is used for the calibration.

Embodiments of the present teachings do not use a fixed or rigid calibration target, but project the calibration marks onto a wall which is as planar as possible, or as free as possible from perturbations, which may for example be doors or passages or joints or seams. In some embodiments, an optical projector projects the marks onto a surface which is as planar as possible, it being assumed that this surface does not satisfy the planarity requirements of the previously used calibration targets but rather, depending on the structure, may lie in the range of a few mm to cm. The surface used for the calibration may thus to a good or very good approximation be regarded as planar.

The errors resulting from the planarity deviation in the measurement reference, and therefore for the calibration, are what are called cosine errors in metrology, or second-order errors, since steps in the surface make more perturbations which, depending on the position with respect to the camera, may lead to second-order errors and, in particular cases, also to first-order errors. For the calibration, it is important for the measuring structure to record different calibration patterns. This may be achieved when the calibration projector and/or measuring structure can be moved relative to the wall. Projection of a calibration pattern onto an almost planar surface is carried out. By means of the virtual plane, the method can be simplified and the calibration can become more effective.

In some embodiments, by means of a computer instrument and a plurality of recordings of the measuring apparatus, the quality of the real plane wall or real plane surface may be mathematically calculated, and the effect of this quality may be mathematically corrected. On the basis of the overdetermination during the image recording with more recordings than absolutely necessary, the quality of the approximately planar surface can be jointly determined during the calibration and the effect of this quality can be computationally corrected.

In some embodiments, by means of a computer instrument, calibration parameters may be determined in one step or intrinsic and external calibration parameters may be determined separately in two steps.

In some embodiments, by means of a polarizer or a beam splitter, two calibration patterns laterally spatially displaced with respect to one another by a beam offset providing a measurement reference may be produced. The beam may be split on the basis of the polarization, and the split parts may be mutually spatially offset. In technical terms, this corresponds to the generation of new light sources which are mutually incoherent because of the different polarization. The patterns may propagate freely in space or be imaged by means of optics into the region to be measured, or onto the wall. The projection of the calibration marks, or patterns, may be carried out with coherent or incoherent light sources.

In order to obtain a scale for the calibration of the lateral dimensions, a scale may be marked on the wall plane or placed in front of the wall. In some embodiments, the optical pattern from the pattern projector is split in a beam splitter and then so to speak doubly projected with a lateral displacement. Thus, each element of the pattern can have a corresponding element of the displaced pattern. Over the entire wall onto which the calibration pattern is projected, there is then this distance for calibration of the lateral dimensions. Because of the purely lateral displacement, the distance is preserved over the entire projection depth. The doubling of the pattern over this basic distance therefore transports a lateral dimension.

In some embodiments, the light projector may comprise a light source, in particular a laser, collimation optics and a pattern generator, which is configured in particular as a pattern plate.

In some embodiments, the pattern plate may be configured as a transmission structure, as a refractive, diffractive or reflective structure, or as a computer-generated hologram. The pattern plate may be configured as a diapositive, i.e. as a transmission structure having a binary pattern or pattern with different brightness levels. In some embodiments, the pattern may be configured as a refractive or diffractive structure, as a diffractive optical element, or as a computer-generated hologram. In some embodiments, the pattern plate may likewise be configured to be reflective, for example as a structured mirror, as a mirrored diffractive optical element or as a computer-generated hologram.

In some embodiments, the light projector may comprise a coherent or semicoherent light source, in which case a coherence reducer, in particular speckle suppression, may be positioned between the pattern generator and collimation optics arranged after the light source in the beam path. The pattern plate is illuminated by an illumination device. In the case of semicoherent or coherent light sources, a coherence reducer may likewise be provided. This may, for example, consist of birefringent plane-parallel plates which are introduced into the collimated beam. Coherence reduction therefore takes place in the case of coherent or semicoherent light sources in order to improve an imaging quality.

In some embodiments, a multiplicity of plates may be arranged successively in the beam path, principal axes of a respective plate being rotatable with respect to the principal axes of the preceding plate by an angle, in particular by 45°. This may be referred to as cascading. Thus, for each beam, two further beams are formed, although these are then still partially mutually coherent so long as the temporal coherence of the light source is greater than the temporal offset of the wavefronts due to the retardation by the birefringence, or the lateral offset is less than the spatial coherence of the light source. After n plates, there is then a superposition of 2n beams, which reduces the contrast of coherence effects in the case of coherent and semicoherent light bundles.

In some embodiments, a respective calibration pattern may comprise geometrical shapes, in particular points, circles, crosses, squares or line portions. The pattern plate in this case generates the pattern desired for the calibration, which may consist of lines, grids, points, circles, crosses, squares or other geometrical shapes. These shapes may be arranged regularly.

In some embodiments, a coherence reducer may be arranged between the collimation optics and the pattern plate.

In some embodiments, the geometrical shapes may be position-encoded. The projected pattern may contain structures which allow unique localization and orientation of the pattern in the recording region of the measuring apparatus. Thus, the position of the pattern relative to the recording region of the measuring apparatus, which may for example be a camera, may then be determined uniquely.

In some embodiments, the geometrical shapes may have a predetermined angular size. The patterns, projected into the space, of the pattern projector are likewise projected as angular objects, i.e. as objects which have a predetermined angular size. A pattern projector for generating the calibration object is regarded as an angular object.

In some embodiments, by means of a computer instrument, an angular error between mutually displaced parts may be taken into account by means of triangulation during the calibration. If an angular error between the split parts occurs during the beam splitting, this may be determined and taken into account during the calibration, since the local distance of the wall can then be determined from the triangulation with the basic difference and two angles of structures which, for example, are superimposed on the wall.

In some embodiments, the entire apparatus or constituent parts of the apparatus and the recording region of the measuring apparatus or the plane wall or plane surface may be movable relative to one another. That is to say, the calibration projector and/or the measuring structure may be moved relative to the wall. The following different calibration scenarios are possible:

1. The calibration projector static with respect to the plane surface, the measuring structure being displaced.
2. The calibration projector and the measuring structure are jointly displaced relative to the plane surface.
3. The calibration projector and the measuring structure are displaced independently relative to the plane surface.

In some embodiments, the light projector may consist of material with a low thermal expansion coefficient, in particular Zerodur, Suprasil, fused silica. The angular calibration of the pattern projector is assumed as a known quantity. If the pattern projector is made from an LTE material, i.e. with a low thermal expansion coefficient, such as for example Zerodur, Suprasil, fused silica etc., the calibration is likewise maintained in the event of relatively large temperature variations.

In some embodiments, the light projector may be optically stabilized, in particular by means of an absorption cell or a reference station. In this way, the wavelength of the light used for the projection can be kept as constant as possible, which may be achieved by optical stabilization, for example by means of an absorption cell or reference station.

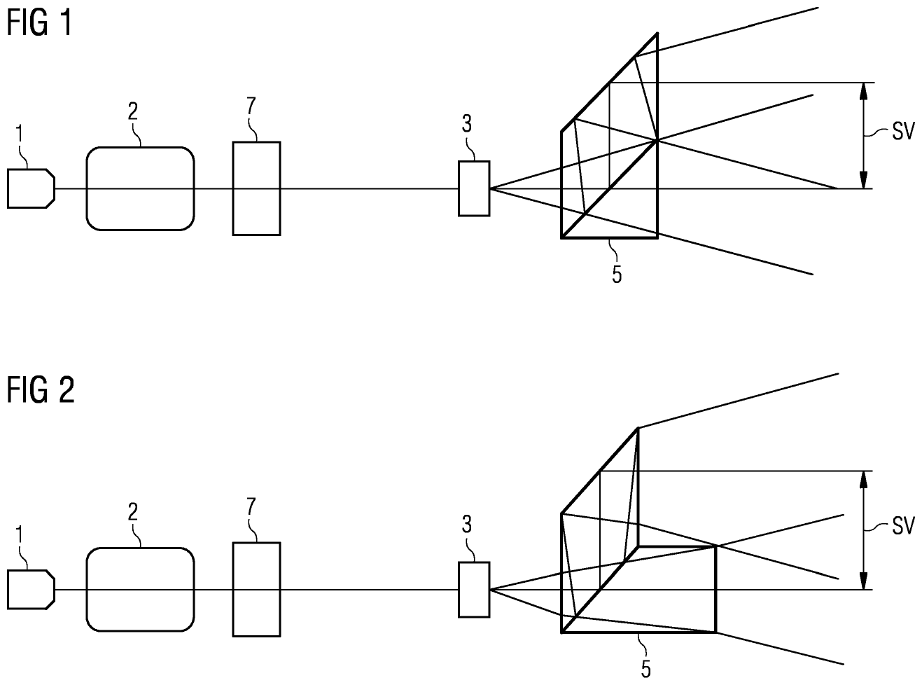

FIG. 1 shows a first embodiment of a device incorporating teachings of the present disclosure. FIG. 1 shows a device for calibrating a measuring apparatus which is used for measuring a measurement object. In this case, the example device is suitable in particular for measurement objects which extend in space in the range of from 0 to e.g. 6 m per spatial axis. The measuring apparatus has a recording region which records the entire measurement object.

By means of a light projector, different calibration patterns Ni can be projected into the recording region of the measuring apparatus onto a plane wall or a plane surface. In this case, reference 1 denotes a light source, which may in particular be configured as a laser. Reference 2 denotes collimation optics, which may be followed by a coherence reducer 7, particularly in the configuration of speckle suppression. Positioned further in the beam profile from the light source 1, there is a pattern generator 3, which may in particular be configured as a pattern plate.

This is followed in the beam path by a polarizer or beam splitter 5, which can generate at least two calibration patterns M1 and M2 laterally spatially displaced with respect to one another with a beam offset providing a measurement reference. This beam offset is a lateral measurement reference. This beam offset is intended to be formed as accurately as possible between two parallel beams which emerge again from the device. FIG. 1 represents only the principle and does not take into account the propagation paths of the light in the beam splitter 5 and likewise no effects there due to refraction of the light. FIG. 1 thus illustrates the concept of a calibration method incorporating teachings of the present disclosure.

In the measurement of large structures as measurement objects, the question of suitable calibration likewise still arises. To this end, there are conventionally different approaches, which lead to different achievable accuracies or require significantly different outlay. Conventional exemplary embodiments are, for example, calibration tables. Disadvantageously, for measurement errors >0.5 m², the calibration tables are large, heavy and unwieldy, and furthermore are likewise expensive for higher accuracy requirements. Photogrammetry represents another conventional solution. In this case, for calibration of the system, a number of calibration marks are applied on the measurement object or in the space of the recording region, and the system is calibrated thereto. After the calibration, the calibration marks are collected again. If the calibration marks are applied on the measurement object, they typically also cover parts of the object, which then cannot be recorded during the measurement.

In the case of stereoscopic systems with two cameras, besides the calibration of the measurement volume a depth map must then be compiled for the cameras from the recording of the disparity. For the lateral dimension determination, a scale or a measurement reference is typically jointly recorded in at least one measurement from the calibration data set. Thus, in principle, the system may be calibrated in its measurement volume.

FIG. 1 illustrates an example calibration method, wherein a light pattern is projected onto the measurement object for the calibration. This may likewise be carried out during the measurement, and therefore simultaneously with the data recording. There is a plurality of different types of light patterns as exemplary embodiments of light patterns. Patterns may be formed from geometrical shapes, for example points, circles, crosses or line portions. The arrangement of the geometrical shapes may also be carried out with encoding of the position. For example, this may be done by means of the arrangement of the shapes relative to one another, in which case the encoding may be repeated after relatively large subregions of the recording region. In order to introduce a scale, the light pattern may be doubled and the two light patterns may be displaced relative to one another so as then likewise to jointly project a reference scale by means of the doubled pattern. In this case, a displacement of the two patterns may be carried out along an axis, which is inclined toward the base line, which may also be referred to as an epipolar line, of the triangulation and may lie in a plane perpendicular to the optical axis of the incoming light. Separation of the two light patterns M1 and M2 may be carried out by means of polarization or by means of a polarization-neutral beam splitter 5. As an alternative thereto, the two light patterns may be generated with two different light colors, or light wavelengths.

FIG. 2 shows a second embodiment of a device incorporating teachings of the present disclosure. In contrast to FIG. 1, FIG. 2 schematically takes into account the refraction on the light paths in the beam splitter 5.

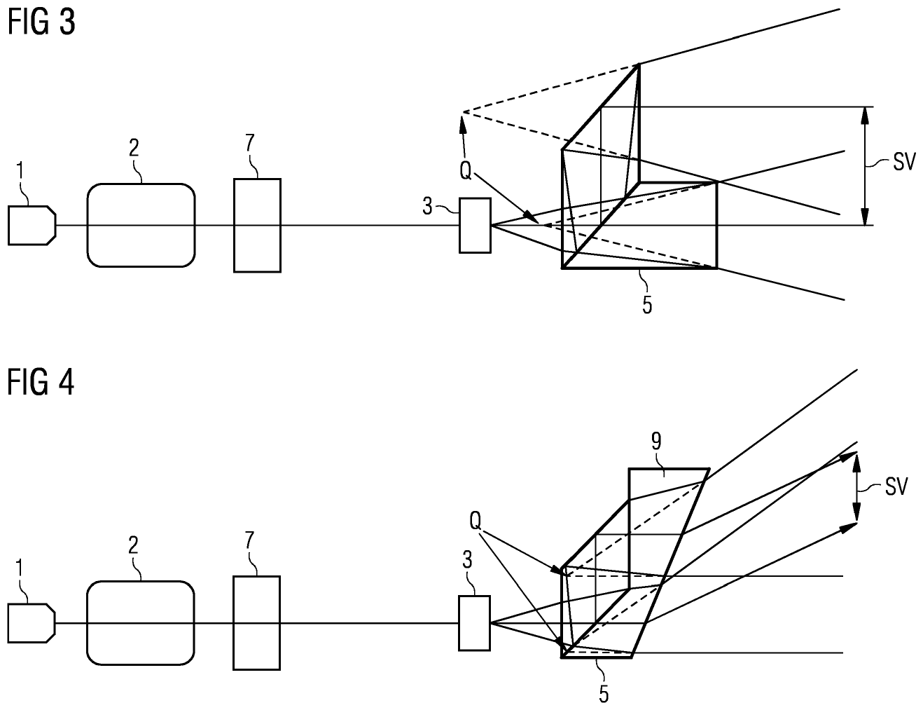

FIG. 3 shows a third embodiment of a device incorporating teachings of the present disclosure. In contrast to FIG. 1, FIG. 3 schematically takes into account the refraction on the light paths in the gray beam splitter 5. In this case, reference Q represents an effective source of the pattern projector, or of the device. The dashed lines for the effective sources Q of the device show that they are laterally offset by means of the beam splitter 5 and furthermore likewise axially by means of the glass paths. The effect of the axial displacement is that the two patterns M1 and M2 are captured with a different size on the wall. Thus, corresponding points on the wall then have an offset which is composed of the lateral offset due to the beam splitting and an additional offset due to the axial displacement of the sources Q. The additional offset is position-dependent in the pattern and depends on the emission angle of the pattern generator 3 for the relevant element. For mutually corresponding elements, the offset is constant but it is different between the elements because of the emission angle.

FIG. 4 shows a fourth embodiment of a device incorporating teachings of the present disclosure. An effective source Q of the device is likewise represented in FIG. 4. A correction prism 9 is furthermore introduced in FIG. 4. FIG. 4 schematically takes into account the refraction on the light paths in the gray beam splitter 5. In a corresponding way to FIGS. 1 to 3, a beam offset S4, which may be used as a lateral scale, is likewise generated in FIG. 4.

The dashed lines for the effective sources Q of the device, or of the pattern projector, show that they are laterally offset by means of the beam splitter 5 and furthermore likewise axially by means of the glass paths. The axial displacement may be adjusted by means of a correction prism 9 and also be fully adjusted symmetrically by means of a particular, or determined, prism angle α. This particular angle depends on the wavelength and the refractive index, or the dispersion, of the glass material used.

The module of the splitter 5 consists, for example, of a triangular prism and a rhombohedron, which is a prism with a parallelogram as its base face, and a correction prism. The proposed monolithic structure allows maximum stability, both mechanically and thermally, and may be made of quartz glass. For further optimization, the pattern generator may likewise be arranged on the front surface of the beam splitter 5. Optical reflection losses of the group of the beam splitter 5 may be minimized by means of nonreflective coatings, or by means of optical contact bonding of the surface.

As a result of the use of the correction prism 9, in contrast to FIG. 3, according to FIG. 4 the effective sources Q have an interchanged position in the axial direction. This shows that full correction is likewise possible. FIG. 4 therefore shows an outline diagram of a device according to the invention in the configuration of a beam axis which is symmetrized, in contrast to FIG. 3.

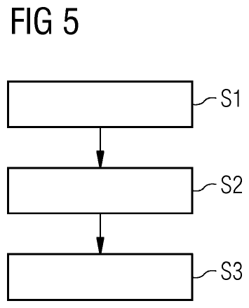

FIG. 5 shows a first embodiment of a method incorporating teachings of the present disclosure. By the method, a measuring apparatus which is intended to measure measurement objects that extend in the region of meters in space is calibrated. In this case, a device is introduced in a first step S1 into the recording region of the measuring apparatus, in such a way that the device projects a first pattern M1 by means of a light projector into the recording region of the measuring apparatus in the direction of a plane wall or a plane surface.

In a second step S2, of a further calibration pattern M2, which is displaced laterally spatially with a beam offset with respect to the first calibration pattern M1, is carried out by means of a polarizer or a beam splitter or by modifying the light wavelength of the light source. The beam offset in this way represents a scale with which measuring apparatuses can be compared with one another.

By a third step S3, by means of a computer instrument, an angular error between mutually displaced parts of the calibration patterns M1 and M2 may be taken into account by means of triangulation during the calibration.

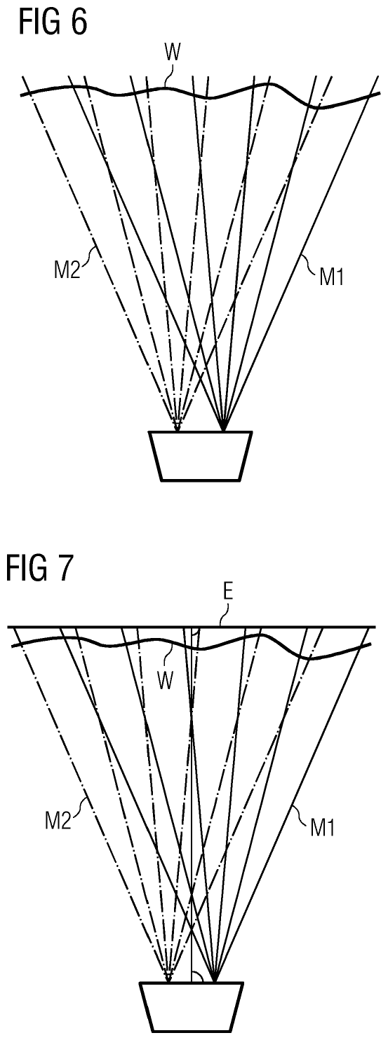

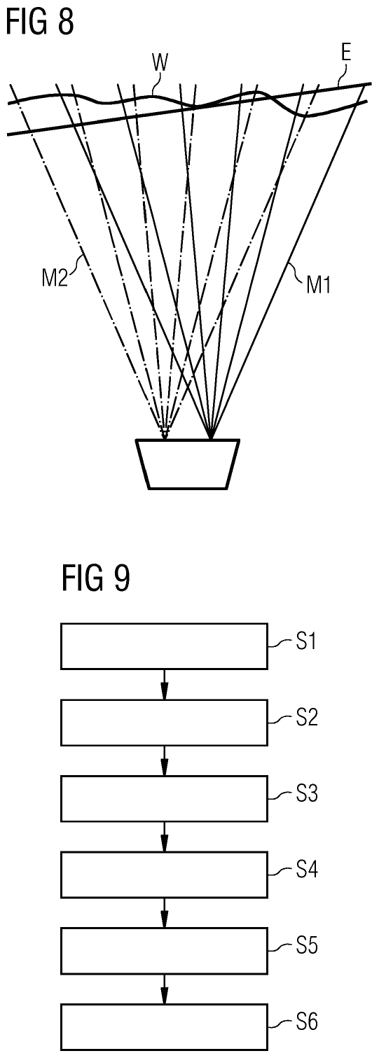

FIG. 6 shows a first representation of the optimization of a method incorporating teachings of the present disclosure. In this case, FIG. 6 represents the projection of a first calibration pattern M1 and a second calibration pattern M2, laterally offset with respect thereto. This is likewise represented by FIG. 7 and FIG. 8. In this case, reference W represents a real plane wall or a real plane surface.

The following optimization of a calibration method incorporating teachings of the present disclosure with the following steps will be proposed in connection with FIGS. 6, 7 and 8:

In a first step, recording of images with the camera to be calibrated, or with the cameras to be calibrated, as exemplary embodiments of measuring apparatus is carried out. In a second step S2, determination of the positions of the points, or objects, of the projected calibration pattern in the respective camera image is carried out.

By a third step S3, determination of the beam directions of the projection beams is carried out for each of the points, or for each of the objects, from the set of recorded calibration images. As a result of this method step S3 there is then a direction field of beam directions for the calibration projector. There is not yet a lateral dimension. In this third step S3, the approximation assumption may be made that the surface onto which the calibration patterns, or calibration marks, have been projected is a plane surface. This is likely to be necessary only when a linear measurement reference is required for the first calculation, which may then approximately be obtained from the projection of the two laterally displaced patterns, pattern M1 and pattern M2. Yet since the pattern projector remains in a fixed position with respect to the wall during the recording of all the images, relative calibration without metric information should also be possible without this step.

In a fourth step S4, calculation of a virtual calibration plane E is carried out, the ideal incidence positions of the beams on the ideal plane E, i.e. a mathematically exact plane surface E, being determined exactly for all the points, or objects, from the projected pattern. In this plane E, the metric calibration may then likewise be carried out, since here the two projected patterns M1 and M2 have the distance predetermined from the projection device. This distance may optionally be corrected by geometrical effects from the relative position of the projection device and the virtual calibration plane E. Likewise, during this correction, inaccuracies in the relative position and orientation of the projected patterns Mi, which are likewise previously known or have been determined from a previous calibration, or factory calibration, may likewise be jointly taken into account computationally. In some embodiments, in the fourth step S4 more generally a calibration surface or a calibration body of known geometry may likewise be referred to, which for example in a preferred configuration becomes a plane.

In a fifth step S5, compilation of a final calibration data set for this calibration is carried out for the measuring structure to be calibrated. By a sixth step S6, provision of the calibration data set for use in a measurement, for example by means of measuring and/or evaluating software, is carried out.

The virtual calibration plane E calculated in the fourth step S4 may, according to FIG. 7, be arranged ideally perpendicularly to the central projection direction for the projected calibration structures, or calibration patterns M1 and M2.

Many methods for calibrating camera-based measuring systems optimize intrinsic and external calibration parameters in a common step. In this case, the intrinsic calibration parameters describe the properties of the camera and of the objective, in the setting selected for the calibration. The external parameters then likewise comprise the properties of the calibration object.

The methods described here are suitable for stepwise determination of the calibration parameters. For example, the intrinsic parameters are initially determined, and the external parameters are then determined in at least one further step. As an alternative, the entire calibration may likewise be carried out in one step. In order to reduce the computation outlay and likewise the calibration outlay, for example through the number of images required, it is likewise possible, for example in the case of recalibration, for the intrinsic parameters to be kept and for only the external parameters to be at least newly determined, or optimized, by the recalibration.

A minimal variant would be to provide a pattern which comprises at least two mutually parallel beams. As an alternative, there could be one pattern and a further light beam, or a further pattern that is on a parallel beam path to one of the projection paths to one of the beams/objects from the pattern.

In some embodiments, two patterns M1 and M2 with a known angular distribution for the projected beams or objects could likewise simply be projected. The distance of the projector from the wall for various regions of the image may be calculated from the relative position of the beams or objects from the two patterns. The position of the projection wall may be calculated therefrom and, together with the distance of the two patterns M1 and M2 and the respective—optionally previously—calibrated angular distributions, the lateral distances of the individual points are then determined as local measurement references on the projection wall, so that full calibration including the metrics is possible. With the virtual plane E introduced here as a central concept, the accuracy of a device according to the invention or of a method according to the invention can be effectively increased.

FIG. 9 shows a second embodiment of a method incorporating teachings of the present disclosure. In the fourth step S4, in which a virtual plane E is likewise adopted in the direction field of the pattern projector or of the device according to the invention for the projected points/objects for metric calibration, and the ideal positions of the points/objects are then determined for this plane E and this information is then used for the metric calibration.

A determination of the calibration parameters may be carried out in a common step for all the calibration parameters, or in at least two separate steps. In the case of at least two separate steps, for example, determination of intrinsic parameters and external parameters may be carried out separately. Further separate steps of the determination of calibration parameters may be carried out by only partially determining calibration parameters during a recalibration, or to check a calibration.

FIG. 8 shows an embodiment of a virtual ideal plane E for the metric calibration, the ideal plane E being freely selected but having a fixed location/position relative to the projection unit in the projection region of the two patterns. In this case, the location is favorably in the working region of the sensor to be calibrated. This, however, is not compulsory.

What is claimed is:

1. A device for calibrating a measuring apparatus for measuring a measurement object extending along an axis in space, the device comprising:
an active region recording an entirety of the measurement object;
a light projector generating at least two different calibration patterns into the active region onto a real plane wall or real plane surface; and
a processor calculating the real plane wall or real plane surface as an ideally plane wall or ideally plane surface and using the calculation for calibration.

2. The device as claimed in claim 1, wherein the processor incorporates a plurality of recordings of the measuring apparatus to calculate a quality of the real plane wall or real plane surface and account for an effect of the quality.

3. The device as claimed in claim 1, wherein the processor determines calibration parameters in one step and/or intrinsic and external calibration parameters are determined separately in two steps.

4. The device as claimed in claim 1, wherein at least two calibration patterns are generated by polarizer or a beam splitter or by means of different light wavelengths; and
the at least two calibration patterns are laterally spatially displaced with respect to one another by a beam offset providing a measurement reference.

5. The device as claimed in claim 4, wherein the light projector comprises:
a light source;
collimation optics; and
a pattern generator.

6. The device as claimed in claim 5, wherein the pattern plate comprises at least one structure selected from the group consisting of: a transmission structure, a refractive structure, a diffractive structure, a reflective structure, and a computer-generated hologram.

7. The device as claimed in claim 1, wherein the light projector comprises:
a coherent or semicoherent light source;
collimation optics arranged downstream of the light source in the beam path; and
a coherence reducer positioned between the pattern generator and the collimation optics.

8. The device as claimed in claim 7, wherein the coherence reducer comprises birefringent plane-parallel plates.

9. The device as claimed in claim 8, further comprising a multiplicity of plates arranged successively in the beam path;
wherein principal axes of a respective plate are rotated with respect to the principal axes of the preceding plate by a non-zero angle.

10. The device as claimed in claim 1, wherein a respective calibration pattern comprises geometrical shapes.

11. The device as claimed in claim 1, wherein the geometrical shapes are position-encoded.

12. The device as claimed in claim 1, wherein the geometrical shapes have a predetermined angular size.

13. The device as claimed in claim 1, wherein the processor corrects for an angular error between mutually displaced parts using triangulation during the calibration.

14. The device as claimed in claim 1, wherein the entire device and/or constituent parts of the device and the space, the recording region or the plane wall or plane surface, are movable relative to one another.

15. The device as claimed in claim 1, wherein the light projector comprises at least one material with a low thermal expansion coefficient selected from the group consisting of: Zerodur, Suprasil, and fused silica.

16. The device as claimed in claim 1, wherein the light projector is optically stabilized by an absorption cell or a reference station.

17. A method for calibrating a measuring apparatus for measuring a measurement object which extends along an axis with an active recording region which records the entire measurement object, the method comprising:
projecting at least two different calibration patterns using a light projector into the active region onto a real plane wall or real plane surface;
calculating the real plane wall or real plane surface as an ideally plane wall or ideally plane surface; and
using the calculated ideal plane for the calibration.

18. The method as claimed in claim 17, further comprising:
calculating by means of the computer instrument and a plurality of recordings of the measuring apparatus, the quality of the real plane wall or real plane surface; and
accounting for an effect of the quality.

19. The method as claimed in claim 17, further comprising, by means of a processor, either:
determining calibration parameters in one step; or
determining intrinsic and external calibration parameters separately in two steps.

20. The method as claimed in claim 17, further comprising using a polarizer or a beam splitter, or using different light wavelengths, to produce two calibration patterns laterally spatially displaced with respect to one another by a beam offset providing a measurement reference or scale.

21. The method as claimed in claim 20, wherein the light projector comprises:
a light source;
collimation optics; and
a pattern generator.

22. The method as claimed in claim 21, wherein the pattern generator comprises at least one structure selected from the group consisting of: a transmission structure, a refractive structure, a diffractive structure, a reflective structure, and a computer-generated hologram.

23. The method as claimed in claim 17, wherein the light projector comprises:
a coherent or semicoherent light source;
collimation optics downstream of the light source in the beam path; and
a coherence reducer positioned between the pattern generator and the collimation optics.

24. The method as claimed in claim 23, wherein the coherence reducer comprises birefringent plane-parallel plates.

25. The method as claimed in claim 24, wherein a multiplicity of plates are arranged successively in the beam path; and
principal axes of a respective plate are rotated with respect to principal axes of the preceding plate by a non-zero angle.

26. The method as claimed in claim 17, wherein a respective calibration pattern comprises geometrical shapes.

27. The method as claimed in claim 26, wherein the geometrical shapes are position-encoded.

28. The method as claimed in claim 26, wherein the geometrical shapes have a predetermined angular size.

29. The method as claimed in claim 17, further comprising accounting for an angular error between mutually displaced parts by triangulation during the calibration.

30. The method as claimed in claim 17, wherein the entire device or constituent parts of the device and the space, the recording region or the plane wall or plane surface are movable relative to one another.

31. The method as claimed in claim 17, wherein the light projector comprises at least one material with a low thermal expansion coefficient selected from the group consisting of: Zerodur, Suprasil, and fused silica.

32. The method as claimed in claim 17, wherein the light projector is optically stabilized, in particular by means of an absorption cell or a reference station.
